(19) United States
(12) Patent Application Publication
(10) Pub. No.: US 2023/0090554 A1
(43) Pub. Date: Mar. 23, 2023

(54) Powdered Food Product and Method of Making the Same

(71) Applicant: Jacques H. Kechichian, Valencia, CA (US)

(72) Inventor: Jacques H. Kechichian, Valencia, CA (US)

(21) Appl. No.: 17/949,534

(22) Filed: Sep. 21, 2022

Related U.S. Application Data
(60) Provisional application No. 63/246,446, filed on Sep. 21, 2021.

(51) Int. Cl. A23L 11/00; A23L 3/44

(52) U.S. Cl. CPC A23L 11/05; A23L 3/44

(57) ABSTRACT

A method of producing a powdered food product includes the steps of (a) fully preparing a fresh food product that is ready for consumption, wherein the fresh food product is one of a dip, a sauce, and a spread, (b) spreading the fresh food product into a layer, (c) freeze-drying the layer of fresh food product, and (d) grinding the freeze-dried fresh food product into a powder. A method of making an edible food product includes the steps of combining only water with the powdered food product.

### CROSS-REFERENCE TO RELATED APPLICATIONS

This application claims the priority benefit of U.S. Provisional Patent Application No. 63/246,446 filed on Sep. 21, 2021.

### STATEMENT REGARDING FEDERALLY SPONSORED RESEARCH

Not applicable

### PARTIES TO A JOINT RESEARCH AGREEMENT

Not Applicable

### REFERENCE TO APPENDIX

Not applicable

### FIELD OF THE INVENTION

The field of the present invention generally relates to powdered food products and, more particularly, to powdered dips, sauces, and spreads with excellent restorability.

### BACKGROUND OF THE INVENTION

Fresh dips, sauces, and spreads are popular around the world. However, most of these fresh dips, sauces, and spreads must be refrigerated resulting in a relatively short shelf life. In the United States (U.S.), refrigerated dips and spreads mainly comprise hummus, salsa, guacamole and yogurt-based products. These dips, sauces, and spreads have a large variety of uses. For example but not limited to, they may be eaten with vegetables, fruits, crackers, chips, pita, bagels, rolls and the like.

Within the fresh dip category in the U.S., hummus accounted for a 45.8 percent of sales in 2017. The sales trend of this Mediterranean favorite was exceptional over the past decade as a growing number of consumers were looking for a healthy and nutritious spread. The ethnic-inspired dip generated U.S. retail sales amounting to almost 700 million U.S. dollars in 2014. The U S hummus market is dominated by the top-selling Sabra Dipping Company which controlled about 60.7 percent of the market in 2015. In Canada, Sabra's award-winning hummus captured about 24 percent of the hummus category.

Plant-based eating is projected to become more and more popular across the board and vegetarian and vegan consumers will be looking for a good source of protein in order to meet their nutritional needs. Industry experts see high potential in hummus as well as other dips, sauces, and spreads including Muhammara and Greek yogurt-based dips and spreads.

While the popularity of these refrigerated dips, sauces, and spreads is rapidly growing, their need to be refrigerated and resulting short shelf like is a problem. Because these refrigerated food products may need to be discarded after only a few days on the shelf, they are often only provided in limited quantities on grocery shelves resulting frequent unavailability.

Many food stuffs are available in a freeze-dried form to greatly enhance their shelf life. These freeze-dried foods stuffs are often used as ingredients for food products in a very effective manner. However, freeze-dried end products typically have undesirable taste, texture and/or nutrients. In other words, these freeze dried end-products cannot adequately restored to their pre-dried taste, texture and/or nutrients.

Accordingly, there is a need for improved freeze-dried food products with excellent restorability.

### SUMMARY OF THE INVENTION

The present invention provides a powdered food product and method of making the same which overcomes at least one of the above described problems in the prior art. Disclosed herein is a method of producing powdered food product comprising the steps of, in combination, (a) fully preparing a fresh food product that is ready for consumption, (b) spreading the fresh food product into a layer, (c) freeze-drying the layer of fresh food product, and (d) grinding the freeze-dried fresh food product into a powder. The fresh food product is one of a dip, a sauce, and a spread.

Also disclosed herein is an edible powdered food product produced by a method comprising the steps of, in combination, (a) fully preparing a fresh food product that is ready for consumption, (b) spreading the fresh food product into a layer, (c) freeze-drying the layer of fresh food product, and (d) grinding the freeze-dried fresh food product into a powder. The fresh food product is one of a dip, a sauce, and a spread;

Additionally disclosed herein is an edible food product consisting essentially of water; and a powdered food product. The powdered food product is produced by a method comprising the steps of, in combination, (a) fully preparing a fresh food product that is ready for consumption, (b) spreading the fresh food product into a layer; (c) freeze-drying the layer of fresh food product, and (d) grinding the freeze-dried fresh food product into a powder. The fresh food product is one of a dip, a sauce, and a spread.

Further disclosed herein is method of making a food product comprising the steps of combining only water with a powdered food product. The powdered food product is produced by a method comprising the steps of, in combination, (a) fully preparing a fresh food product that is ready for consumption, (b) spreading the fresh food product into a layer, (c) freeze-drying the layer of fresh food product, and (d) grinding the freeze-dried fresh food product into a powder. The fresh food product is one of a dip, a sauce, and a spread;

From the foregoing disclosure and the following more detailed description of various preferred embodiments it will be apparent to those skilled in the art that the present invention provides a significant advance in the technology and art of powdered food products and methods of making powdered food products. Particularly, significant in this regard is the potential the invention affords for providing fresh food products, that typically require refrigeration, with dramatically longer shelf life without any significant change to taste, texture, and/or nutrients and without the use of preservatives. Additional features and advantages of the invention will be better understood in views of the detailed description provided below.

### BRIEF DESCRIPTION OF THE DRAWINGS

These and further objects of the invention will become apparent from the following detailed description.

FIG. 1 is a flow-chart showing a method of making powdered food product according to the present invention.

FIG. 2 is a flow-chart showing a method of making powdered hummus according to the method of FIG. 1.

FIG. 3 is a flow-chart showing a method of making and edible food product from powdered hummus produced according to the method of FIG. 1.

### DETAILED DESCRIPTION OF CERTAIN PREFERRED EMBODIMENTS

It will be apparent to those of ordinary skill in the art, that is to those who have knowledge or experience in this area of technology, that many uses and design variations are possible for the powdered food products disclosed herein. The following detailed discussion of various alternative and preferred embodiments will illustrate the general principles of the invention with regard to the specific application of powdered hummus. Other embodiments suitable for other applications will be apparent to those skilled in the art given the benefit of this disclosure such as, for example but not limited to, other powdered bean dips (for example but not limited to, fava bean, black bean, pinto bean, and the like), other powdered dips (for example but not limited to, a dip like hummus but having roasted eggplant and yogurt replacing the garbanzo beans, and the like), powdered sauces, (for example but not limited to marinara, alfredo, and the like), powdered spreads, and the like.

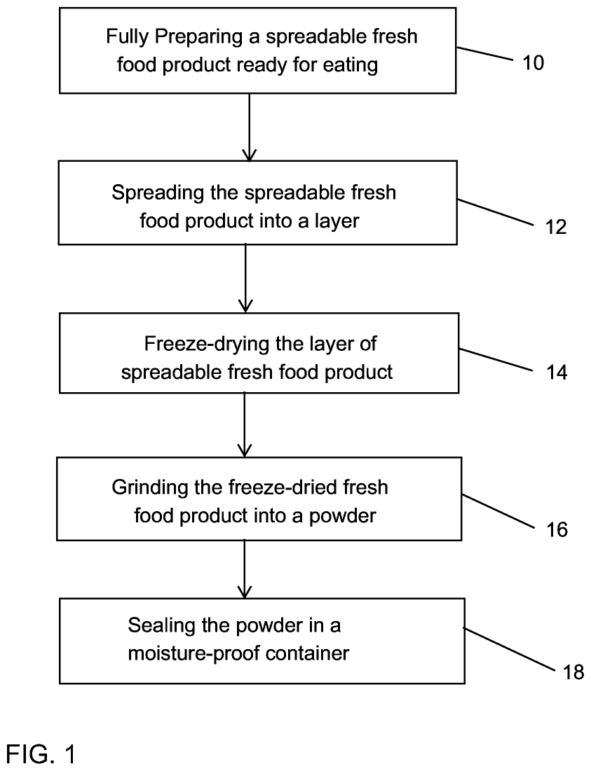

FIG. 1 illustrates a method for producing a powdered food product according to the present invention. The illustrated method for producing a powdered food product includes the steps of Step A—fully preparing a fresh food product that is ready for consumption (10), wherein the fresh food product is one of a dip, a sauce, and a spread, Step B—spreading the fresh food product into a layer (12), Step C—freeze-drying the layer of fresh food product (14); Step D—grinding the freeze-dried fresh food product into a powder (16), and Step E— sealing the powder in a moisture-proof container (18).

The term “food product” is used herein and in the claims to mean a completed dish or meal of food containing a plurality of ingredients that is completely prepared or cooked so that it is ready to eat or is ready for eating or consumption and does not require further ingredients or preparation. The term “fresh food product” is used herein and in the claims to mean a food product that has not been preserved, does not contain added preservatives, and has not spoiled yet. The term “powdered food product” is used herein and in the claims to mean a food product that has been dried and ground into discrete small particles. The term “dip” is used herein and in the claims to mean a thick sauce into which pieces of food are dunked before eating. The term “sauce” is used herein and in the claims to mean thick liquid served with food, usually savory dishes, to add moistness and flavor. The term “spread” is used herein and in the claims to mean a spreadable thick food product that is typically spread onto breads, crackers, and the like to enhance the flavor and texture.

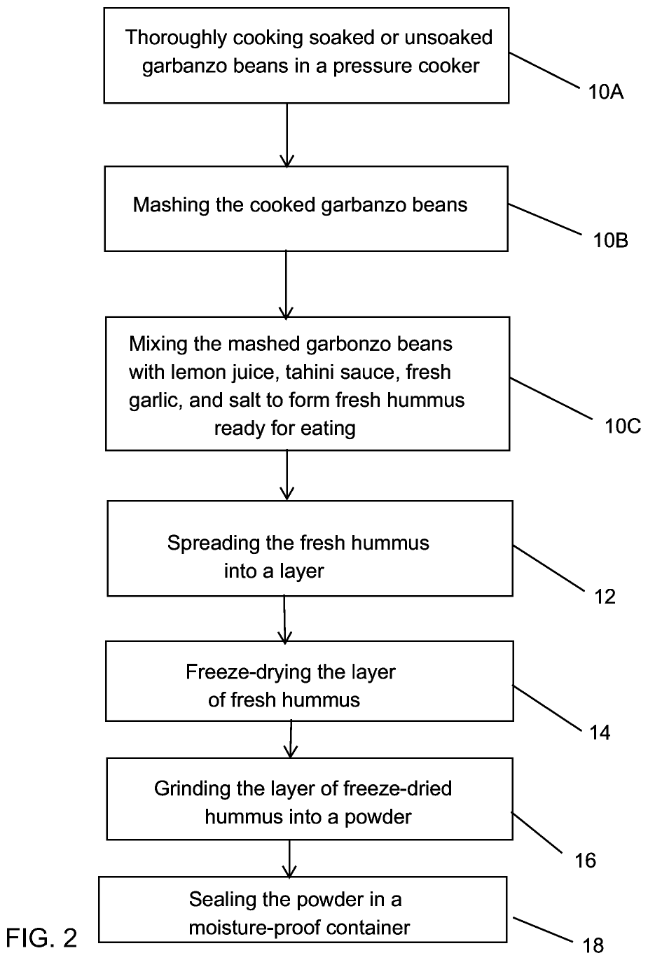

FIG. 2 illustrates an exemplary embodiment of the illustrated method wherein the fresh food product is a hummus dip. The illustrated method for producing powdered hummus dip includes the steps of Step A1 pressure cooking garbanzo beans also known as chick peas (10A), Step A2 mashing the cooked garbanzo beans (10B), Step A3 mixing the mashed garbanzo beans with fresh lemon juice, tahini sauce, fresh garlic, and salt to form fresh hummus dip that is ready for consumption (10C), Step B—spreading the fresh food product into a layer (12), Step C—freeze-drying the fresh hummus dip (14), Step D—grinding the freeze-dried fresh hummus dip into a powder (16), and Step E— sealing the powder in a moisture-proof container (18).

Step A1 includes obtaining a suitable quantity of garbanzo beans, preferably fresh garbanzo beans (10A. The garbanzo beans are preferably soaked overnight to remove the outer skins. The soaked or un-soaked garbanzo beans are then placed into a pressure cooker and covered with water. The pressure cooker's lid is secured and the pressure is set to high. The garbanzo beans, are then thoroughly cooked until they can be mashed. This typically takes about 20 to 30 minutes or more for soaked beans and about 30 to 40 minutes or more for un-soaked beans. The pressure cooker is then naturally depressurized. Natural decompression typically requires 10 or more minutes. Any remaining liquid in the pressure cooker is drained from the cooked garbanzo beans. Any remaining outer skins of the garbanzo beans are removed.

Step A2 is to mash the cooked garbanzo beans with a potato masher or the like until a chunky texture is obtained (10B). Any remaining outer skins are separated and discarded. The garbanzo beans can be mashed in the pressure cooker or moved to any other suitable location for mashing.

Step A3 includes transferring the mashed garbanzo beans to a food processor or the like and adding suitable quantities of lemon juice, tahini sauce, garlic, and salt (10C). The tahini sauce is typically a mixture of toasted or untoasted sesame seeds and olive oil. The garlic can be fresh garlic or garlic powder. The ingredients are then mixed using the food processor until creamy and smooth. Water can be added if needed to obtain the desired texture. Typically, the ingredients are mixed about 5 minutes. The resulting product is finished fresh hummus dip ready to eat.

Exemplary quantities for preparing the fresh humus dip includes mixing about 2 cups of the mashed garbanzo beans, the lemon juice squeezed from about 2 whole lemons, about 5 tablespoons of the tahini sauce, about one clove of minced garlic, and about 1 teaspoon of salt. The mixture is then adjusted to taste. It is noted that any other suitable quantities of the ingredients can alternatively be utilized. It is also noted that this results in fresh hummus dip ready for consumption

Step B includes spreading the completed fresh hummus dip into a layer (12). The layer of fresh hummus dip can be formed on any suitable tray or the like that fits within the freeze-drying machine. The thickness of the layer can be any suitable thickness for reducing the time of freeze drying.

Step C includes freeze-drying the layer of fresh hummus dip (14). Preferably the fresh hummus is freeze-dried in a sublimation type freeze-drying machine wherein the hummus is frozen and placed under vacuum to remove all water directly from solid to vapor. The fresh hummus is preferably dried to remove about 99% or more of the moisture from the fresh hummus. The freeze drying process typically takes about 24 hours or more.

Step D includes grinding the freeze-dried hummus dip into a powder having a suitable particle size. The freeze-dried hummus dip can be ground using a grinding mill, milling machine, pulverizer, hammer mill, or the like. The resulting powder is powdered hummus.

Step E includes sealing the powder in a moisture free container (18). The container can be of any suitable type having a seal to prevent the ingress of moisture to the powder. The better the seal of the container, the longer the shelf life of the powdered food product. It is noted that the container can be of any suitable size such as, for example, a single serving container used for restoring the hummus dip within the container by a consumer or a vending machine, or a large container to be stored over a long period of time for emergency readiness.

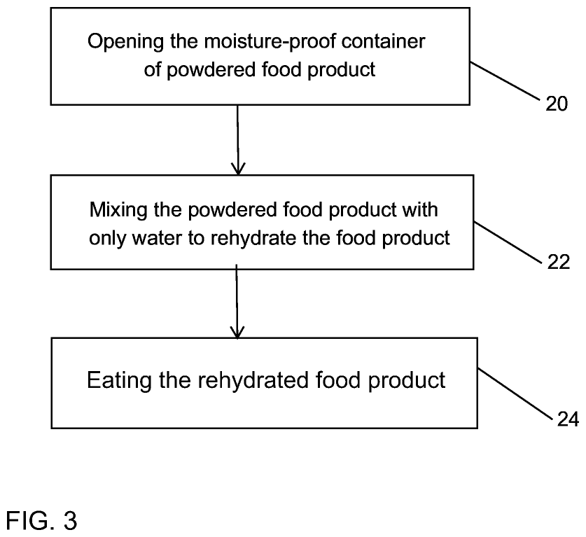

FIG. 3 illustrates a method of making or restoring edible hummus dip from the above-described powdered hummus dip. The restored edible hummus has a taste, texture and nutrients of the fresh hummus dip prepared prior to the freeze-drying. Step A includes obtaining and opening a moisture-free container of the powder hummus dip or other desired powdered food product (20). Step B includes mixing a suitable quantity of the powdered humus dip with only water to restore or re-hydrate the hummus dip (22). Typically the mixture ratio is about 5 to 2: that is, about 5 tablespoons of powdered food product is mixed with about 2 tablespoons of water. However, any other suitable ratio can alternatively be utilized. The mixing can take place within the container itself or any other suitable location such as a bowl or the like. Step C includes eating or consuming some or all of the restored food product (24). Typically, vegetables or bread is dipped into the hummus dip but it can alternatively be eaten in any other suitable manner.

It is noted that each of the features of the various disclosed embodiments of the present invention can be utilized in any combination with each of the other disclosed embodiments of the present invention.

From the above disclosure it can be appreciated that powdered hummus prepared according to the present invention has a vastly improved shelf life and can be easily and quickly converted back to edible hummus dip. It can also be appreciated that hummus dip prepared from the hummus powder according to the present inventions is restored to its pre-dried taste, texture and nutrients when combined with only adding water. It can further be appreciated that the hummus dip according to the present invention can advantageously be utilized in vending machines to serve hummus dip.

The preferred embodiments of this invention can be achieved by many techniques and methods known to persons who are skilled in this field. To those skilled and knowledgeable in the arts to which the present invention pertains, many widely differing embodiments will be suggested by the foregoing without departing from the intent and scope of the present invention. The descriptions and disclosures herein are intended solely for purposes of illustration and should not be construed as limiting the scope of the present invention.

What is claimed is:

1. A method of producing a powdered food product comprising the steps of, in combination:
(a) fully preparing a fresh food product that is ready for consumption, wherein the fresh food product is one of a dip, a sauce, and a spread;
(b) spreading the fresh food product into a layer;
(c) freeze-drying the layer of fresh food product; and
(d) grinding the freeze-dried fresh food product into a powder.

2. The method of producing powdered food product according to claim 1, wherein the fresh food product includes an oil.

3. The method of producing powdered food product according to claim 1, wherein the fresh food product is hummus.

4. The method of producing powdered food product according to claim 3, wherein the hummus includes olive oil.

5. The method of producing powdered food product according to claim 1, wherein the powdered food product is free of preservatives.

6. The method of producing powdered food product according to claim 1, further comprising the step of sealing the powder in a moisture-free container.

7. The method of producing powdered food product according to claim 1, wherein the step of freeze-drying the layer of fresh food product removes at least 99% of moisture from the layer of fresh food product.

8. Powdered food product produced by a method comprising the steps of, in combination:
(a) fully preparing a fresh food product that is ready for consumption, wherein the fresh food product is one of a dip, a sauce, and a spread;
(b) spreading the fresh food product into a layer;
(c) freeze-drying the layer of fresh food product; and
(d) grinding the freeze-dried fresh food product into a powder.

9. The powdered food product according to claim 8, wherein the fresh food product includes an oil.

10. The powdered food product according to claim 8, wherein the fresh food product is hummus.

11. The powdered food product according to claim 10, wherein the hummus includes olive oil.

12. powdered food product according to claim 8, wherein the powdered food product is free of preservatives.

13. The powdered food product according to claim 9, further comprising the step of sealing the powder in a moisture-free container.

14. The powdered food product according to claim 8, wherein the step of freeze-drying the layer of fresh food product removes at least 99% of moisture from the layer of fresh food product.

15. A method of making an edible food product comprising the steps of:
combining only water with a powdered food product; and
wherein the powdered food product is produced by a method comprising the steps of, in combination:
(a) fully preparing a fresh food product that is ready for consumption, wherein the fresh food product is one of a dip, a sauce, and a spread;
(b) spreading the fresh food product into a layer;
(c) freeze-drying the layer of fresh food product; and
(d) grinding the freeze-dried fresh food product into a powder.

16. The method of making an edible food product according to claim 15, wherein the fresh food product includes an oil.

17. The method of making an edible food product according to claim 15, wherein the fresh food product is hummus.

18. The method of making an edible food product according to claim 17, wherein the hummus includes olive oil.

19. The method of making an edible food product according to claim 15, wherein the step of freeze-drying the layer of fresh food product removes at least 99% of moisture from the layer of fresh food product.

20. The method of making an edible food product according to claim 15 according to claim 15, wherein a mixing ratio of powdered food product to water is about 5:2.
